(19) United States
(12) Patent Application Publication
(10) Pub. No.: US 2026/0280404 A1
(43) Pub. Date: Sep. 17, 2026

(54) INFORMATION PROCESSING APPARATUS AND ABNORMALITY DETECTION METHOD

(71) Applicant: Fujitsu Limited, Kawasaki-shi (JP)

(72) Inventor: Kazuya OKAMOTO, Kawasaki (JP)

(73) Assignee: Fujitsu Limited, Kawasaki-shi (JP)

(21) Appl. No.: 19/461,002

(22) Filed: Jan. 27, 2026

(30) Foreign Application Priority Data
Mar. 14, 2025 (JP) 2025-041227

(51) Int. Cl. H02M 1/00; H02M 3/158

(52) U.S. Cl. CPC H02M 1/0025; H02M 3/1584

(57) ABSTRACT

An apparatus includes a power supply unit and a control device configured to control the power supply unit. The power supply unit includes a power conversion circuit including a switching element. The control device includes a processor configured to perform a process including: obtaining, from the power supply unit, an index value indicating a switching time of the switching element set in the power conversion circuit, and detecting an abnormality of the power supply unit based on the obtained index value and an index value accumulated in the past.

### CROSS-REFERENCE TO RELATED APPLICATION

This application is based upon and claims the benefit of priority of the prior Japanese Patent Application No. 2025-041227, filed on Mar. 14, 2025, the entire contents of which are incorporated herein by reference.

### FIELD

The present disclosure relates to an information processing apparatus and an abnormality detection method.

### BACKGROUND

In an information processing apparatus that causes a plurality of power supply units to operate in parallel according to a load, a technique is known for improving the power efficiency of the plurality of power supply units by increasing or decreasing the number of power supply units that supply power. In such a technique, the power supply units that supply power to the load and the power supply units in which the power supply is stopped are periodically switched.

For example, related arts are disclosed in Japanese Laid-open Patent Publication No. 2012-175885 and Japanese Laid-open Patent Publication No. 2018-207732.

### SUMMARY

According to an aspect of the embodiment, an information processing apparatus including: a power supply unit including a power conversion circuit including a switching element; and a control device configured to control the power supply unit, wherein the control device comprises a processor configured to perform a process including: obtaining, from the power supply unit, an index value indicating a switching time of the switching element set in the power conversion circuit, and detecting an abnormality of the power supply unit based on the obtained index value and an index value accumulated in the past.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a hardware configuration of a server according to one embodiment;

FIG. 2 is a block diagram illustrating an example of a hardware configuration of a power supply unit according to one embodiment;

FIG. 3 is a block diagram illustrating an example of a hardware configuration of a power supply unit, which depicts in detail a controller and a power conversion circuit;

FIG. 4 is a diagram illustrating one example of an accumulated value;

FIG. 5 is a block diagram illustrating an example of a functional configuration of a control unit according to one embodiment;

FIG. 6 is a diagram illustrating one example of an accumulated value table;

FIG. 7 is a diagram illustrating one example of initial values and degraded values of accumulated values;

FIG. 8 is a graph illustrating examples of the relationship between the efficiency and the load current of a power supply unit;

FIG. 9 is a flowchart for explaining an example of an operation of the server according to one embodiment; and

FIG. 10 is a flowchart for explaining an example of an operation of the server according to one embodiment.

### DESCRIPTION OF EMBODIMENTS

In the above-described technique, although it is possible to exclude a failed power supply unit (for example, a power supply unit that has become incapable of operating) from the switching candidates, when a failure of a power supply unit occurs during parallel operation, the operation of the information processing apparatus may become unstable.

The above-described inconvenience is not limited to cases where a plurality of power supply units operate in parallel, and can similarly occur even when power is supplied to the load from a single power supply unit.

Hereinafter, an embodiment of the present disclosure will be described with reference to the drawings. However, the embodiment described below is merely exemplary, and it is not intended to exclude various modifications or applications of techniques that are not explicitly described below. For example, the present embodiment can be modified in various manners without departing from the spirit thereof. In the drawings used in the description below, parts denoted by the same reference symbols represent the same or similar parts unless otherwise stated.

### (A) Example of Configuration of Server according to One Embodiment

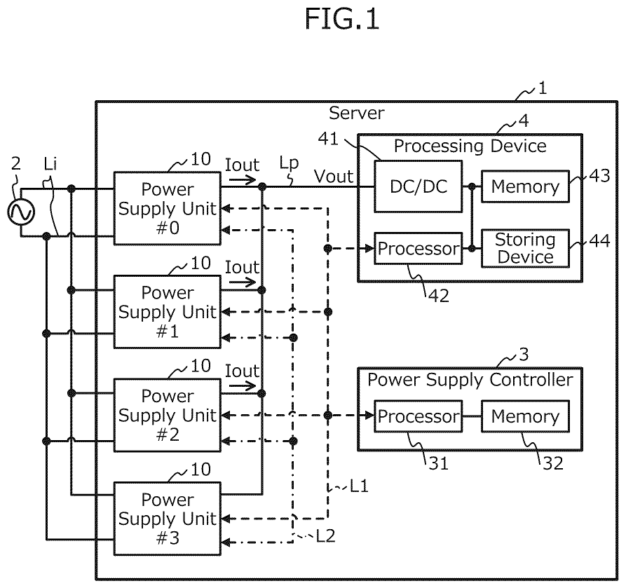

FIG. 1 is a block diagram illustrating an example of the hardware configuration of a server 1 according to one embodiment. The server 1 is one example of a computer, an information processing apparatus, or an information processing system that operates using power supplied from a power source external to the server 1 (external power source). Although FIG. 1 illustrates an example in which the server 1 operates using AC power supplied from an external AC power source 2, the server 1 may instead operate using DC power supplied from an external DC power source. Furthermore, although FIG. 1 illustrates an example in which the external power source is a single power system, the external power source may have two or more power systems (multiple power systems).

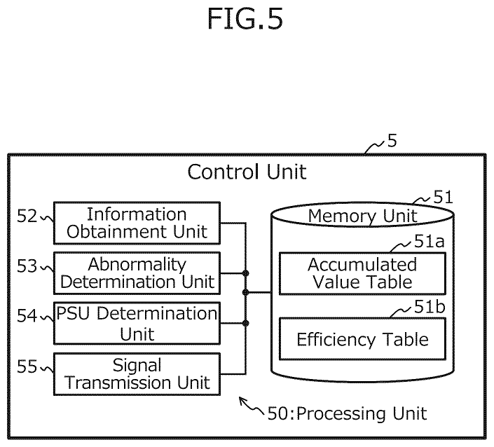

As illustrated in FIG. 1, the server 1 includes a plurality of (four in FIG. 1) power supply units 10 (denoted as power supply units #0 to #3 in FIG. 1), a power supply controller 3, and a processing device 4. One or both of the power supply controller 3 and the processing device 4 is one example of a controller configured to control the plurality of power supply units 10, and may implement functions as a control unit 5 described later (see FIG. 5).

Each power supply unit 10 is connected to a common output line Lp. In the following description, an example is presented in which the server 1 includes four power supply units #0 to #3. However, the number of power supply units 10 provided in the server 1 may be increased or decreased as appropriate depending on the power consumption of the processing device 4, the number of redundant units in a redundant configuration, the number of power systems in the external power source, and the like. In one embodiment, although it is assumed that the plurality of power supply units 10 have equivalent performance, the performances of the power supply units 10 may differ from each other. In the following description, the term “power supply unit” may be referred to as “PSU.”

The power supply controller 3 controls the plurality of PSUS 10. Note that the power supply controller 3 may be provided inside at least one of the power supply units 10. Furthermore, when the processing device 4 is used as the control unit 5, the power supply controller 3 may be omitted.

The power supply controller 3 may include, for example, a processor 31 and a memory 32. The processor 31 is one example of a processing unit that performs various controls and calculations in the power supply controller 3. Examples of the processor 31 include integrated circuits (ICs) such as a CPU, MPU, APU, DSP, ASIC, or FPGA, for example. CPU is an abbreviation for Central Processing Unit, and MPU is an abbreviation for Micro Processing Unit. APU is an abbreviation for Accelerated Processing Unit. DSP is an abbreviation for Digital Signal Processor, ASIC is an abbreviation for Application Specific IC, and FPGA is an abbreviation for Field-Programmable Gate Array.

The memory 32 is one example of a storage unit, and stores various data, programs, and other information used in the power supply controller 3. The memory 32 may store that embodies functions of the power supply firmware (FW) controller 3 described later and control information. Examples of the memory 32 include one or both of volatile memory such as Dynamic Random Access Memory (DRAM), and non-volatile memory such as Storage Class Memory (SCM) or Read Only Memory (ROM), for example.

The processing device 4 is, for example, a processing functional unit that performs information processing in the server 1, and is one example of a “load” or a load device in the server 1. The processing device 4 is connected to the output line Lp of the plurality of PSUs 10 and operates by the power supplied from the plurality of PSUs 10 via the output line Lp.

Furthermore, when at least one of the power supply controller 3 and the processing device 4 functions as the control unit 5, it may be communicably connected with each of the PSUs #0 to #3 via a signal line L1, and may control each of the PSUs #0 to #3 by transmitting and receiving control signals S1 via the signal line L1.

The processing device 4 may include, for example, a Direct Current (DC)-DC converter 41, a processor 42, a memory 43, and a storing device 44. In the drawings described below, the “DC-DC converter” may be referred to as “DC/DC.”

The DC-DC converter 41 converts the output voltage (DC voltage) Vout applied to the output line Lp into respective operating voltages for the processor 42, the memory 43, and the storing device 44 (for example, step-down conversion). Then, the DC-DC converter 41 outputs the respective converted voltages to the processor 42, the memory 43, and the storing device 44.

The processor 42 is one example of a processor or processing unit that performs various controls and calculations in the processing device 4. Examples of the processor 42 include integrated circuits (ICs) such as a CPU, MPU, APU, DSP, ASIC, or FPGA, for example. The processor 42 may be a combination of two or more of these integrated circuits.

Each of the memory 43 and the storing device 44 stores various data, programs, and other information used in the processing device 4. Examples of the memory 43 include one or both of volatile memory such as DRAM and nonvolatile memory such as SCM, for example. Examples of the storing device 44 include various types of storing devices, including magnetic disk devices such as a Hard Disk Drive (HDD), semiconductor drive devices such as a Solid State Drive (SSD), and nonvolatile memory.

Note that the components provided in the processing device 4 are not limited to the above-described components, and the processing device 4 may also include various components such as an accelerator such as a Graphics Processing Unit (GPU), a wired or wireless communication interface (IF), an Input/Output (IO) device, and a reader for reading information from a recording medium. Furthermore, the processing device 4 is not limited to a computer and may be various devices that can serve as a load that consumes power.

The PSU 10 supplies DC power to the processing device 4 by outputting the DC power to the output line Lp relying on power supplied from the external power source. In the example of FIG. 1, the PSU 10 converts AC power input from the AC power supply 2 via the input line Li into DC power and supplies the DC power to the processing device 4 via the output line Lp. Furthermore, the plurality of PSUs 10 are communicatively connected to each other via a signal line L2.

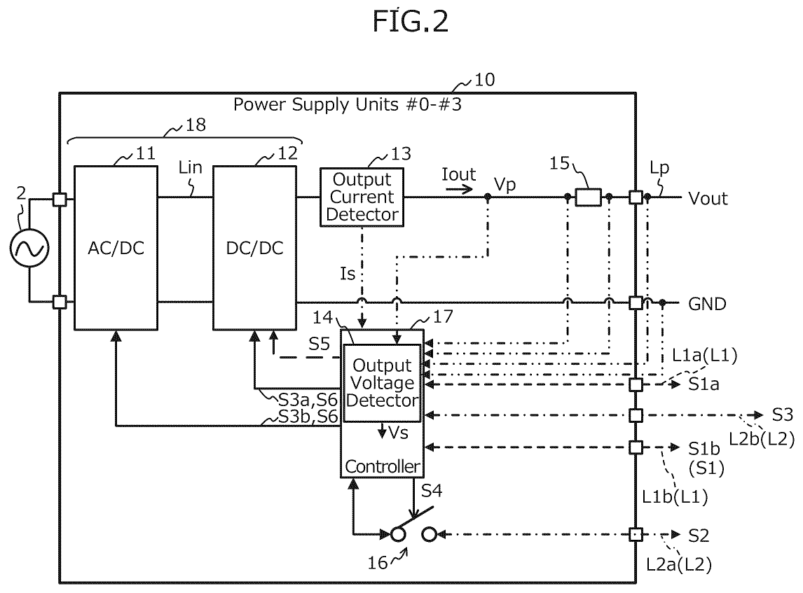

Here, the “power supplying state” refers to a state in which the DC-DC converter 12 (see FIG. 2) supplies power to the processing device 4, and in the following description, this state may also be referred to as the “operating state” or simply “operating.” On the other hand, a state in which the DC-DC converter 12 stops the supply of power to the processing device 4 is referred to as a “stopped state.” A PSU 10 in the stopped state can be regarded as a standby system prepared for a shortage of supply power. Accordingly, in the following description, the stopped state may also be referred to as the “standby state” or simply “standby.” Each of the operating state and the standby state is one mode of the “output state” of the PSU 10.

Each PSU 10 can individually perform switching or maintenance of the output state thereof based on a determination made by the PSU 10 or based on instructions from the power supply controller 3. In the following description, a PSU 10 in the standby state may be referred to as a “standby PSU 10,” and a PSU 10 in the operating state may be referred to as an “operating PSU 10.”

(A-1) Example of Configuration of Power Supply Unit FIG. 2 is a block diagram illustrating an example of the hardware configuration of a power supply unit 10 according to one embodiment. Each of the PSUs 10 (#0 to #3) according to one embodiment includes, for example, an Alternate Current (AC)-DC converter 11, a DC-DC converter 12, an output current detector 13, an output voltage detector 14, a reverse current prevention unit 15, a switch 16, and a controller 17. In the drawings described hereinafter, the “AC-DC converter” may be denoted as “AC/DC.” In the following, at least one of the AC-DC converter 11 and the DC-DC converter 12 may be collectively referred to as the power conversion circuit 18.

The AC-DC converter 11 converts AC power supplied from the external AC power source 2 into DC power, and outputs the DC power to the DC-DC converter 12 via an input line Lin. The AC-DC converter 11 may be connected to the controller 17 via a signal line, and may receive a voltage adjustment signal S3 and a control signal S6 from the controller 17 via the signal line. When the external power source is a DC power source, the AC-DC converter 11 may be omitted, and in such a case, the power conversion circuit 18 may include one or more DC-DC converters 12.

The DC-DC converter 12 is one example of an output unit that outputs power to the processing device 4. The DC-DC converter 12 steps down an input voltage Vin, which is the DC voltage applied to the input line Lin, and applies (outputs) an output voltage Vp, which is the stepped-down DC voltage, to the output line Lp. The DC-DC converter 12 also outputs an output current Tout corresponding to the load, to the output line Lp. The output current Iout is one example of the load current. The DC-DC converter 12 may be connected to the controller 17 via a signal line, and may receive the voltage adjustment signal S3 and the control signal S6 from the controller 17 via the signal line.

When in the operating state, the DC-DC converter 12 outputs, as the output voltage Vp, a voltage with a voltage value V1 that is one example of the first voltage value, to the output line Lp. When power is supplied to the processing device 4 by any of the PSUs #0 to #3, the voltage value on the output line Lp (output voltage Vout) becomes equal to the voltage value V1 of the output voltage Vp of the operating PSUs 10.

Here, the current value of the output current Iout output from the operating PSU 10 is determined according to the power consumption of the processing device 4, and is adjusted by the current balancing function so that the magnitude of the output current Iout matches between the other operating PSUs 10. Accordingly, when a plurality of operating PSUs 10 in parallel operation all have equivalent performance (specifications) and the current balancing function of each operating PSU 10 is enabled, both the output voltage Vp and the output current Iout (in other words, the output power) become equivalent among the plurality of operating PSUs 10.

The current balancing function is a function for matching the current values of the output currents Iout output to the output line Lp among the plurality of operating PSUs 10. The current balancing function may be achieved, for example, by controlling the DC-DC converter 12 by a current balance circuit (not illustrated) provided in the controller 17. For example, by transmitting and receiving a current balance signal S2 via a signal line L2a between a plurality of controllers 17 in the operating state, the current balance circuit controls the plurality of DC-DC converters 12 so that the output currents Iout match. The current balance signal S2 may be a signal indicating a value that has a positive correlation with the output current Iout of the operating PSU 10, for example.

The current balancing function includes a voltage adjustment function as a related function. The voltage adjustment function is a function for increasing or decreasing the output voltage value of the output voltage Vp so that the equal output currents Iout are output from the plurality of DC-DC converters 12 in the operating state. Note that the voltage adjustment function may also be embodied by a circuit provided in the power conversion circuit 18 (for example, a current balance circuit and a circuit provided in the AC-DC converter 11), and may be embodied by the cooperation of these circuits. For example, by transmitting and receiving voltage adjustment signals S3 (S3a and S3b) via the controller 17 and a signal line L2b among the plurality of operating PSUs 10, the power conversion circuit 18 may control the output voltages Vp such that the output currents Iout match among the plurality of operating PSUs 10,. The voltage adjustment signals S3 (S3a and S3b) are signals used for controlling the voltage adjustment function, and may be signals indicating values that have a negative correlation with the output current Iout of the operating PSUs 10, for example. The voltage adjustment signal S3a is a signal transmitted and received by the DC-DC converter 12, and the voltage adjustment signal S3b is a signal transmitted and received by the AC-DC converter 11.

When in the standby state, the DC-DC converter 12 outputs, as the output voltage Vp, a voltage with a voltage value V2 that is slightly smaller than the voltage value V1 in the operating state, to the output line Lp. The voltage value V2 is one example of the second voltage value and may be about 80% to 98% of the voltage value V1, for example. As long as the voltage value V2 of the output voltage Vp of the DC-DC converter 12 in the standby state is smaller than the voltage value of the output voltage Vout (see FIG. 1) on the output line Lp, reverse current from the operating PSUs 10 is prevented by the reverse current prevention unit 15 described later. In other words, the current value of the output current Iout of the DC-DC converter 12 in the standby state becomes zero, similarly to when the PSU 10 is completely stopped (for example, when both the output voltage Vp and the output current Iout are set to zero).

In the standby state, the current balancing function and the voltage adjustment function described above are both disabled in order for the DC-DC converter 12 to maintain the output voltage Vp at the voltage value V2. By disabling these functions, the output voltage Vp is maintained at the voltage value V2 without the voltage value changing in response to increases or decreases in the load current. In addition, the output current Iout is prevented from being affected by the load current of other operating PSUs 10 and is maintained at zero. Thus, by disabling these functions, the output voltage Vp of the DC-DC converter 12 can be stabilized at the voltage value V2 and the output current Iout can be made zero, thereby facilitating transition to the standby state.

Enabling and disabling of the current balancing function and the voltage adjustment function may be controlled by the controller 17 in hardware or in software. Enabling or disabling of these functions may be performed by various methods, including enabling or disabling of the circuits implementing the functions, switching to a path or bypass path through the circuits, and changing signals or setting values. In the following description, enabling these functions to set the PSUs 10 (the DC-DC converter 12) to the operating state may be collectively referred to as “enabling control.” In contrast, disabling these functions to set the PSUs 10 (the DC-DC converter 12) to the standby state may be collectively referred to as “disabling control.”

Note that the method of setting the PSU 10 to the standby state is not limited to the method described above, and a state in which the PSU 10 is completely stopped may be defined as the standby state. In this case, the standby PSU 10 may have both the output voltage Vp and the output current Iout set to zero.

The output current detector 13 is an element or a circuit that measures the magnitude of a current. Examples of the output current detector 13 include various sensors, resistors (for example, those connected in series on a line so that the voltage across both ends is measured by the controller 17 to calculate the current value), and current detection elements. The output current detector 13 outputs to the controller 17 a current detection signal Is indicating the magnitude of the output current Iout output from the DC-DC converter 12.

The output voltage detector 14 is an element or circuit that measures the magnitude of voltage and may be, for example, various sensors. The output voltage detector 14 outputs a voltage detection signal Vs indicating the magnitude of the output voltage Vp on the output line Lp. In the example of FIG. 2, the output voltage detector 14 may be provided inside the controller 17. The output voltage Vp between the DC-DC converter 12 and the reverse current prevention unit 15, the voltage on the output line Lp on the processing device 4 side relative to the reverse current prevention unit 15 (for example, the output voltage Vout), and the voltage on the GND line may each be input to the output voltage detector 14, and signals indicating the magnitudes of various voltages may be output using these.

The reverse current prevention unit 15 prevents reverse current from the output line Lp on the processing device 4 side into the DC-DC converter 12. The reverse current prevention unit 15 may include a semiconductor element such as a Field Effect Transistor (FET), for example, and may be interposed on the output line Lp inside the PSU 10. The reverse current prevention unit 15 turns off (disconnects) the output line Lp inside the PSU 10 when the output voltage Vp of the DC-DC converter 12 is lower than the voltage (output voltage Vout) on the output line Lp on the processing device 4 side, and turns on (conducts) the output line Lp inside the PSU 10 when the output voltage Vp is equal to or higher than the output voltage Vout. Note that among the various signal lines illustrated in FIG. 2 which are input to the controller 17, those that are duplicated with each other may be omitted as appropriate.

The switch 16 is provided on the signal line L2a to switch the signal line L2a between an ON (connecting) state and an OFF (disconnecting) state according to the state of a switch control signal S4 input from the controller 17 via a control line to the controller 17. In the ON state, transmission and reception of the current balance signal S2 is allowed in the controller 17, thereby enabling the current balancing function. On the other hand, in the OFF state, transmission and reception of the current balance signal S2 is not allowed in the controller 17, thereby disabling the current balancing function. Note that the switch 16 may be provided inside the controller 17.

The controller 17 performs various controls in the PSU 10. Examples of the controller 17 include control circuits such as integrated circuits, for example. Although FIG. 2 illustrates an example in which the PSU 10 includes one controller 17, the PSU 10 may include one or more controllers 17 provided to correspond to each component of the power conversion circuit 18 (the AC-DC converter 11 and the DC-DC converter 12).

The controller 17 is connected to signal lines L1a and L1b and performs communications with the control unit 5 (the power supply controller 3 or the processing device 4) via the signal lines L1a and L1b. The signal lines L1a and L1b are examples of the signal line L1 illustrated in FIG. 1. The signal line L1 (either or both of L1a and L1b) may be a communication bus compliant with a communication standard such as Power Management Bus (PMBus), for example. Each of the signal lines L1a and Lib may be a signal line having two or more wires.

Furthermore, the controller 17 is connected to a signal line L2a and performs transmission and reception of the current balance signal S2 with another PSU 10 via the signal line L2a. Additionally, the controller 17 is connected to a signal line L2b and performs transmission and reception of the voltage adjustment signal S3 with the controllers 17 of other PSUs 10 via the signal line L2b. The signal lines L2a and L2b are examples of the signal line L2 illustrated in FIG. 1.

Controls performed by the controller 17 may include, for example, the stabilization control for stabilizing the output voltage Vp of the power conversion circuit 18, and the efficiency control for improving the power efficiency of the plurality of PSUs 10. In the stabilization control, the switching time of the switching element of t the power conversion circuit 18 is controlled in order to adjust the output voltage Vp, and an index value used for determination as to whether there is a sign of a failure is calculated and transmitted to the control unit 5. In the efficiency control, the output state of the PSU 10 is controlled so as to be switched from the standby state to the operating state, or from the operating state to the standby state. Examples of these controls will be described below.

### (A-1-1) Stabilization Control

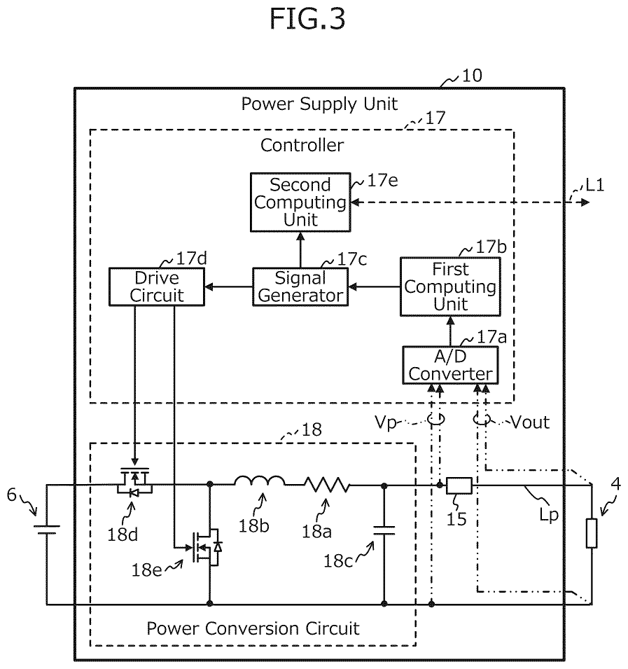

FIG. 3 is a block diagram illustrating an example of the hardware configuration of the power supply unit 10, which depicts in detail the controller 17 and the power conversion circuit 18. Below, with reference to FIG. 3, the stabilization control by the controller 17 will be described.

FIG. 3 illustrates the PSU 10 depicting in detail the controller 17 and the power conversion circuit 18, a power source 6 that supplies power (DC power in the example of FIG. 3) to the power conversion circuit 18, and the processing device 4 as a load to which power is supplied from the PSU 10. Note that the power source 6 may be provided in place of the external AC power supply 2, or the output side of the AC-DC converter 11 (the Lin side in FIG. 2) may be conceptually treated as a DC power supply.

An example of a simplified configuration of the internal circuit of the DC-DC converter 12 of the power conversion circuit 18 is illustrated in FIG. 3. The power conversion circuit 18 includes a circuit resistance 18a, an inductor 18b, a capacitor 18c, and two (a pair of) FETs 18d and 18e. The circuit resistance 18a conceptually represents the total resistance from the input of power to the PSU 10 to the output of power from the PSU 10 (including the reverse current prevention unit 15).

The inductor 18b and the capacitor 18c are examples of a smoothing circuit that smoothes the output power and may be referred to as a low-pass filter. The inductor 18b prevents rapid changes in the output current Iou and smoothes it. The capacitor 18c is, for example, a capacitor that stores electric charge of the current that has passed through the inductor 18b and stabilizes the output voltage Vp.

The FETs 18d and 18e are examples of a switching element. The FET 18d is one example of a high-side switch, and the FET 18e is one example of a low-side switch. The FETs 18d and 18e perform a switching operation by alternately switching between the ON state and the OFF state, thereby outputting a pulse-shaped voltage (power). The pulse-shaped voltage is smoothed in the smoothing circuit. As a result, the output voltage Vp output from the power conversion circuit 18 is kept constant.

In the switching operation, a first state and a second state are alternately repeated. In the first state, the pulse is turned on by turning the FET 18d on and the FET 18e off, whereas in the second state, the pulse is turned off by turning the FET 18d off and the FET 18e on. The sum of the duration of the first state and the duration of the second state is the cycle of the pulse. The duration of the first state may also be referred to as ON time or pulse width. The duration of the second state may also be referred to as OFF time or pulse interval. The ratio of the ON time to the pulse cycle (ON time+OFF time) is one example of the switching time of the switching element.

The voltage value of the output voltage Vp varies according to the ratio of the ON time to the pulse cycle. For example, the voltage value of the output voltage Vp varies according to a change in duty ratio in the case of the Pulse Width Modulation (PWM) control, and according to a change in switching frequency in the case of the Pulse Frequency Modulation (PFM) control.

In the case of the PWM control, the switching frequency is constant. In this case, the voltage value of the output voltage Vp increases as the duty ratio, which indicates the ratio of the ON time to one pulse cycle, increases, and decreases as the duty ratio decreases.

In the case of PFM control, the ON time is constant. In this case, the voltage value of the output voltage Vp increases as the pulse cycle becomes shorter (the OFF time becomes shorter), in other words, as the switching frequency becomes higher. On the other hand, the voltage value of the output voltage Vp decreases as the pulse cycle becomes longer (the OFF time becomes longer), in other words, as the switching frequency is lower.

Note that FIG. 3 illustrates an example of a simplified configuration of the internal circuit of the DC-DC converter 12. However, when the AC-DC converter 11 is included in the power conversion circuit 18, the internal circuit of the AC-DC converter 11 may additionally be included. This internal circuit may include at least two (a pair of) FETs.

In the stabilization control, the controller 17 monitors the voltage value of the output voltage Vp output from the power conversion circuit 18 and adjusts the switching time of the FETs 18d and 18e.

Here, in the PSU 10, as the components degrade, the resistance value of the circuit resistance 18a increases. The components refer, for example, to components in the path from the input of power to the PSU 10 to the output of power, including the internal components of the power conversion circuit 18. As the resistance value increases, the output voltage Vp decreases from the desired output voltage (target output voltage), under the relationship of current X resistance=voltage. The target output voltage is, for example, the voltage value to be output from the PSU 10. As one example, the target output voltage may be the voltage value of the output voltage Vout on the processing device 4 side relative to the reverse current prevention unit 15 on the output line Lp in the case of an operating PSU 10, and may be the voltage value V2 in the case of a standby PSU 10. For example, the voltage adjustment function includes a function of adjusting to a set voltage and a function of increasing or decreasing the voltage for current balancing. By means of the function of adjusting to a set voltage, the voltage value output from the PSU 10 is adjusted to the target output voltage. For these controls, the controller 17 may measure each of the output voltages Vp and Vout by using the control lines and the output voltage detector 14 described with reference to FIG. 2 (see FIG. 3).

The controller 17 lengthens the switching time (ON time per one cycle) in order to raise the voltage value of the decreased output voltage Vp to the voltage value of the target output voltage. First, a relationship between the switching time and the output voltage Vp will be described.

The output voltage Vp, the input voltage Vi that is input from the power source 6, the ON time Ton of the FET 18d (i.e., the OFF time of the FET 18e), and the OFF time Toff of the FET 18d (i.e., the ON time of the FET 18e) have the relationship expressed in the following Expression (1):

$$Vp = Vi \times Ton / ( Ton + Toff ) \qquad ( 1 )$$

Ton/(Ton+Toff) is one example of the switching time (ratio), and in the following description, the setting value thereof may be denoted as Tr. For example, as expressed in the following Expression (2), it is assumed that the output voltage Vp0 coincides with the target output voltage Vt, where Tr0 represents the setting value (initial value) of the switching time set at a reference time point (for example, when a new PSU 10 is introduced):

$$Vp 0 = Vi \times Tr 0 \qquad ( 2 )$$

As the operating time of the PSUs 10 increases along with the operation of the server 1 and degradation of components progresses, the resistance value of the circuit resistance 18a increases. If the setting value Tr0 is set at a certain time point, the output voltage Vp becomes equal to a voltage value Vp1 (=Vp−Δv) that is lower by Δv than Vp0 (the target output voltage Vt), as expressed in the following Expression (3). Here, it is assumed that both the input voltage Vi and the target output voltage Vt remain constant between the reference time point and the certain time point:

$$Vp 1 = Vi \times Tr 0 \qquad ( 3 )$$

As expressed in the following Expression (4), the controller 17 increases the setting value of the switching time from Tr0 to Tr1 (=Tr0+Δt), which is longer than Tr0 by At, so that the output voltage Vp becomes equal to Vp0 (the target output voltage Vt):

$$Vp 0 = Vi \times Tr 1 \qquad ( 4 )$$

Thus, by performing a feedback control that lengthenes the switching time setting value at a certain time point from Tr0 to Tr1 by At, the output voltage Vp can be changed (increased) from Vp1 to Vp0 by Av.

Next, an example of the configuration of the controller 17 for embodying the stabilization control will be described. The controller 17 includes an Analog-Digital (A/D) converter 17a, a first computing unit 17b, a signal generator 17c, a drive circuit 17d, and a second computing unit 17e.

The A/D converter 17a performs analog-to-digital conversion of a signal (analog value) indicating a voltage value and outputs the digital value to the first computing unit 17b. Although FIG. 3 illustrates an example in which a signal indicating the output voltage Vout is input to the A/D converter 17a, a signal indicating the output voltage Vp (for example, the voltage detection signal Vs) may also be additionally input. The signal indicating a voltage value may be the voltage value per se, or may be a signal having a positive correlation with the voltage value.

The first computing unit 17b determines a switching time (for example, the ON time Ton and the OFF time Toff) such that the output voltage Vp coincides with the output voltage Vout, and outputs the switching time to the signal generator 17c. For example, the first computing unit 17b outputs a switching time obtained by adding At to the current switching time so as to increase the difference (Δv) of (output voltage Vout−output voltage Vp).

The signal generator 17c converts the switching time from the first computing unit 17b into a signal and outputs the signal to the drive circuit 17d.

The drive circuit 17d converts the signal from the signal generator 17c into a drive signal (voltage value) for controlling the ON/OFF state of each of the FETs 18d and 18e and drives the FETs 18d and 18e using the drive signals, thereby performing the switching operation. The drive signals output from the drive circuit 17d to each of the FETs 18d and 18e (and each FET in the AC-DC converter 11) are, for example, examples of the control signal S6 illustrated in FIG. 2.

The second computing unit 17e outputs an index value indicating the switching time of the switching element set in the power conversion circuit 18. For example, the second computing unit 17e may transmit the index value to the control unit 5 via the signal lines L1a and L1b by including the index value in the signal S1a.

Here, as described above, the resistance value of the circuit resistance 18a increases as components degrade. In addition, the switching time increases (At increases) as the resistance value increases (the output voltage Vp decreases). For example, due to degradation of the components, the ON resistance of a switching element may increase to 1.2 times or higher. Thus, the change in switching time has a positive correlation with the degree of degradation of the components. Therefore, the second computing unit 17e can indirectly notify the degree of degradation of the components at present by providing the control unit 5 with an index value indicating a switching time that has a positive correlation with the degree of degradation of the PSU 10.

However, since the time to set the switching elements 18d and 18e to the first state (ON time) by the drive circuit 17d is, for example, a very short time on the order of nanoseconds (ns), it may be difficult to detect a change from the initial value directly from the switching time per se.

Therefore, in one embodiment, the second computing unit 17e may use, as the index value, an index value that is related to the relationship between the switching time of the switching element set in the power conversion circuit 18 and the output voltage Vp from the PSU 10 in accordance with the switching time.

For example, the index value may be an index value related to an accumulated value of the switching time set in a following manner to obtain the target output voltage Vt or an increase amount Δt of the switching time, and a change amount Δv of the output voltage Vp from the PSU 10 that changes in accordance with the switching time, during a given period.

Since the change amount Δv of the output voltage Vp is, for example, on the order of millivolts (mV), by accumulating the change amount Δv in the index value in addition to the increase amount Δt in the unit of nanoseconds, detection of the change amount can be facilitated.

In one embodiment, the index value is assumed to be an accumulated value of the setting value Tr1 of the switching time, the increase amount Δt (Tr1−Tr0) from the initial value of the switching time, and the change amount Δv (Vp0−Vp1) of the output voltage Vp. However, the accumulated value may be an accumulated value of the setting value Tr1 and the change amount Δv, or an accumulated value of the increase amount Δt and the change amount Δv. As the setting value of the switching time Tr1, for example, a feedback control amount generated by the first computing unit 17b or the signal generator 17c may be used.

The given period is, for example, a period of several seconds or several minutes to several hours, and may be started when the measurement is instructed by the control unit 5. The accumulated value may be the product (multiplied value) or the sum (added value) of the setting value Tr1, the increase amount Δt, and the change amount Δv, or a combination thereof.

The second computing unit 17e may perform a process of calculating the accumulated value of the setting value Tr1, the increase amount Δt, and the change amount Δv at a certain timing, within the given period. Note that the second computing unit 17e may calculate the accumulated value at a plurality of timings within the given period and add (sum) the accumulated values. The second computing unit 17e may transmit the accumulated value (or summed value) to the control unit 5 as an index value during the given period. Alternatively, the second computing unit 17e may calculate the index value for each load current (output current Iout) or load power of the PSU 10, or for each input voltage (for example, input voltage Vi) of the PSU 10, or for each combination of the output current Iout or load power and the input voltage.

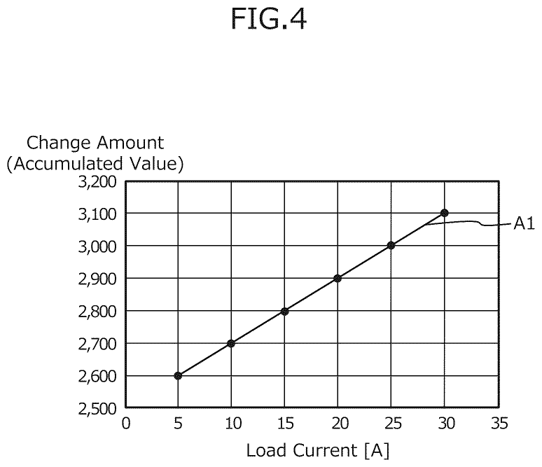

FIG. 4 is a diagram for explaining one example of the accumulated value. The reference symbol A1 in FIG. 4 indicates one example of a change in the accumulated value in accordance with the load current, where the horizontal axis represents the load current (in amperes (A)) and the vertical axis represents the accumulated value. The load current is one example of the load factor. The load factor may be based on load power. As illustrated in FIG. 4, the accumulated value increases in accordance with the increase in the load current (load factor). That is, the accumulated value has a positive correlation with the load current (load factor).

When the accumulated value is obtained as a 16-bit digital value, the second computing unit 17e may detect a change in the range of 15 bits, with 1 bit used as a sign bit. In this case, the range of the change width is a width of 215=+32,768.

### (A-1-2) Efficiency Control

Each controller 17 of all the PSU 10 performs an efficiency control in response to the control signal S1 from the control unit 5.

The controller 17, for example, supplies (outputs) the signal S1a including a signal indicating the load state of the PSU 10 to the control unit 5, via the signal lines L1a and L1b, as information used for control by the control unit 5. The signal indicating the load state of the PSU 10 may include, for example, a signal indicating the value of the output current Iout (as one example, the current detection signal Is). As the signal indicating the load state, for example, a load factor obtained by dividing the output power value of the PSU 10 (output voltage Vp x output current Iout) by the rated power value of the PSU 10 may be used.

Furthermore, the signal S1a may include at least one type of information in addition to the signal indicating the load state, for example:
A signal indicating the value of the input voltage supplied to the power conversion circuit 18. The input voltage may be, for example, the voltage applied to the input line Lin.
In addition to the signal indicating the load state, a signal indicating the internal temperature of the power conversion circuit 18 (for example, the DC-DC converter 12). The internal temperature of the DC-DC converter 12 may be, for example, a component temperature of a device that is mounted in the DC-DC converter 12 and generates heat due to current.
A signal indicating the value of the input current or input power supplied to the power conversion circuit 18.

In the following description, it is assumed that the signals S1a and S1b include the various signals described above. The signals S1a and S1b may further include signals indicating various information requested by the control unit 5. Note that the power conversion circuit 18 may be provided with sensors for detecting each of such various types of information, and the values detected by the sensors may be input to the controller 17.

Based on the signals S1a and S1b obtained from the plurality of controllers 17, the control unit 5 determines the output state to be set for each PSU 10 from the viewpoint of efficiency. The control unit 5 then transmits operation control signals S1a and S1b that control the output state to each PSU 10 (controller 17) via the signal lines L1a and L1b. The operation control signals S1a and S1b may indicate different values depending on whether the instruction is to set the PSU to the operating state (operation instruction) or to the standby state (standby instruction), for example. The operation control signals S1a and S1b may also include various instructions, such as instructions instructing the controller 17 to obtain information. The signal S1a and the operation control signal S1b are examples of the control signal S1.

The controller 17 sets the output state of the local PSU 10 to the operating state or the standby state by performing the enabling control or the disabling control based on the values indicated by the received operation control signals S1a and S1b, for example. In response to receiving the operation control signals S1a and S1b indicating an operation instruction, the controller 17 may perform the enabling control described above.

Enabling or disabling of the current balancing function may be performed by, for example, transmitting a switch control signal S4 from the controller 17 to the switch 16. Enabling or disabling of the voltage adjustment function may be performed, for example, by adjusting each component of the power conversion circuit 18 by the controller 17. For example, the controller 17 may switch between enabling and disabling of the voltage adjustment function based on whether or not an offset is present with respect to a reference voltage.

In response to receiving the operation control signals S1a and S1b indicating an operation instruction, the controller 17 may perform the enabling control. In the enabling control, for example, a switch control signal S4 indicating the ON state of the switch 16 is transmitted from the controller 17, which enables transmission and reception of the current balance signal S2 in the controller 17. As a result, the current balancing function is enabled. Also, for example the voltage adjustment function is enabled by changing whether or not an offset is present with respect to a reference voltage.

Furthermore, in response to receiving the operation control signals S1a and S1b indicating a standby instruction, the controller 17 may perform the disabling control. In the disabling control, for example, the switch control signal S4 indicating the OFF state of the switch 16 is transmitted from the controller 17, which prohibits the transmission and reception of the current balance signal S2 in the controller 17. As a result, the current balancing function is disabled. Furthermore, for example, the voltage adjustment function is disabled by changing whether or not an offset is present with respect to a reference voltage by the controller 17.

In this manner, in the efficiency control, it is possible to control the number of PSUs in the operating state such that the number of operating PSUs 10 is optimized to achieve improved efficiency (for example, maximized efficiency) from the viewpoint of efficiency.

### (A-2) Configuration Example of Control Unit

FIG. 5 is a block diagram illustrating an example of the functional configuration of the control unit 5 according to one embodiment. As illustrated in FIG. 5, the control unit 5 may include a memory unit 51, an information obtainment unit 52, an abnormality determination unit 53, a PSU determination unit 54, and a signal transmission unit 55.

The information obtainment unit 52, the abnormality determination unit 53, the PSU determination unit 54, and the signal transmission unit 55 are examples of the processing unit 50. The functions of the processing unit 50 may be embodied by the processor 42 illustrated in FIG. 1 that executes a program stored in the memory 43. In this case, the memory unit 51 may be embodied using at least a part of the storage areas of the memory 43 and the storing device 44 illustrated in FIG. 1. Alternatively, the functions of the processing unit 50 may be embodied by the processor 31 illustrated in FIG. 1 that executes a program stored in the memory 32, or that operates in accordance with circuit logic set in the processor 31. In this case, the memory unit 51 may be embodied using at least a part of the storage areas of the memory 32 illustrated in FIG. 1.

### (A-2-1) Information Obtainment Unit

The information obtainment unit 52 obtains various information from each of the plurality of PSUs 10. In the stabilization control, the information obtainment unit 52 may obtain, for example, an accumulated value during a given period from each PSU 10 at intervals of one day to several weeks. As one example, the information obtainment unit 52 may instruct each PSU 10 to calculate the accumulated value for one hour (the given period) at intervals such as one week or one month. The information obtainment unit 52 may update the accumulated value table 51a based on the signals S1a and S1b including the accumulated values received from each PSU 10 via the signal lines L1a and L1b.

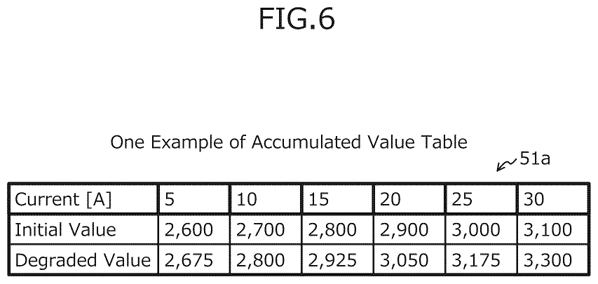

FIG. 6 is a diagram illustrating one example of the accumulated value table 51a. The accumulated value table 51a may be provided for each PSU 10. In the accumulated value table 51a, for example, the initial value and the degraded value (value at present) may be associated with each segment (current value) of current (load current), which is one example of the load factor. The initial value is an accumulated value measured at a reference point in time (for example, the PSU 10 operated for the first time), and is one example of an indicator value accumulated in the past. The degraded value (value at present) is, for example, an accumulated value that is obtained the most recently by the information obtainment unit 52.

Although FIG. 6 illustrates an example in which the initial value and the degraded value are set for each load current, this is not limiting, and an accumulated value measured for at least one load factor may be stored. In this case, in response to obtaining an accumulated value, it is sufficient that, among multiple currents included in the accumulated value table 51a, the degraded value corresponding to the current for which the accumulated value has been obtained is updated. For degraded values corresponding to other currents, the accumulated value obtained in the most recent given period may be retained, or an estimated value obtained by estimation (for example, approximation) from the obtained accumulated value may be set.

Note that the efficiency table 51b may further be provided for each input voltage Vi. The accumulated value table 51a may be generated each time the indicator value is obtained by the information obtainment unit 52, and may be managed so as to be distinguishable from previously generated accumulated value tables 51a. Furthermore, instead of the accumulated value table 51a, the memory unit 51 may store an approximation formula representing the accumulated value in accordance with the load current, for each of the initial value and the degraded value.

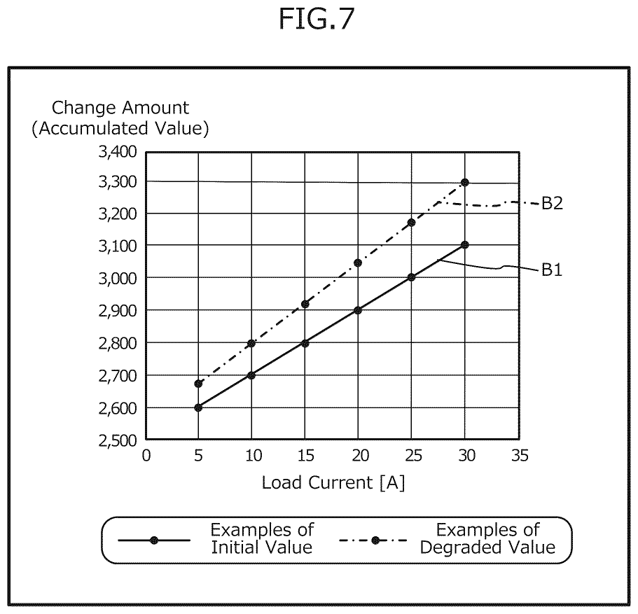

FIG. 7 is a diagram illustrating one example of initial values and the degraded values of accumulated values.

The reference symbol B1 indicates a graph illustrating an approximation formula of the initial values of accumulated values for each load current, and the reference symbol B2 indicates a graph illustrating an approximation formula of the degraded values of accumulated values for each load current. For example, the memory unit 51 may store such approximation formulas (or at least values indicating two or more points for each graph).

In the efficiency control, the information obtainment unit 52 may obtain information at given cycles (for example, several milliseconds to several seconds). The information obtainment unit 52 may obtain the load (for example, the current value of the output current Iout) of each PSU 10 based on the signals S1a and S1b received from each PSU 10 via the signal lines L1a and L1b. Note that the information obtainment unit 52 may further obtain at least one type of information among the input voltage, temperature, and input current or input power of each PSU 10, based on the signals S1a and S1b.

### (A-2-2) Abnormality Determination Unit

In the stabilization control, the abnormality determination unit 53 performs an abnormality determination process for each PSU 10 based on the accumulated value table 51a. The abnormality determination unit 53 may compare, for example, a threshold that is set for each load factor (for example, load current) for detecting an abnormality, with the values stored in the accumulated value table 51a. The threshold may be, for example, a value based on the initial value, and may be a value determined by adding a given value (for example, a fixed value or a value at a given ratio of the initial value) to the initial value.

For example, it is assumed that the initial value of the accumulated value for a current of 20 A is 2, 900, and the threshold for a current of 20 A is 3,000. The threshold is determined by adding a given value of 100 to the initial value. In this case, in the example illustrated in FIG. 6, since the degraded value is 3,050, which is equal to or greater than the threshold, the abnormality determination unit 53 determines that an abnormality has occurred in the corresponding PSU 10. The abnormality determination unit 53 may determine that an abnormality has occurred in the PSU 10 if the degraded value for at least one of the plurality of currents in the accumulated value table 51a exceeds the threshold. Alternatively, the abnormality determination unit 53 may determine that an abnormality has occurred in the PSU 10 if the number of degraded values exceeding the threshold is equal to or greater than a given number.

Here, “abnormality” may mean that, due to the progress of the deterioration of components, the possibility that a failure occurs in the PSU 10 has increased to a given expected value or higher. In other words, the detection of a sign (precursor) of a failure of the PSU 10 is one example of the occurrence of an abnormality in the PSU 10.

When an abnormality is detected, the abnormality determination unit 53 may output abnormality information indicating the abnormality (occurrence of the abnormality) of the PSU 10. The output of the abnormality information may include, for example, recording the abnormality information in the memory unit 51. Furthermore, the output may include, for example, displaying the information on an I/O device of the server r 1, or transmitting the information to an administrator terminal (computer) connected via the communication interface of the server 1 and a network (including the Internet). The abnormality information may include identification information of the PSU 10 in which the abnormality has occurred, in other words, the PSU 10 that has a possibility of a failure in the near future or indicates a sign of a failure. The abnormality information may further include a notification (message) urging replacement of the PSU 10, information on the degraded value that has triggered the detection of the abnormality, and the like.

As described above, in the stabilization control, the control unit 5 detects an abnormality of the PSU 10 based on the indicator value obtained from the PSU 10 and a indicator value (initial value) accumulated in the past. Accordingly, it is possible to detect an abnormality of the PSU 10, including the possibility of occurrence of a failure.

In addition, the indicator value is an indicator value that is related to the relationship between the switching time and the output voltage Vp, and has a correlation with the degree of deterioration of the PSU 10. The abnormality determination unit 53 outputs information indicating an abnormality of the PSU 10 when the obtained indicator value has increased by a given value or more from the initial value. Accordingly, an abnormality detection can be performed more accurately according to the degree of deterioration.

### (A-2-3) PSU Determination Unit and Signal Transmission Unit

In the efficiency control, the PSU determination unit 54 determines the number N (N is an integer of one or more) of PSUs 10 to be set to the operating state based on information obtained from the plurality of PSUs 10. Note that the PSU determination unit 53 may perform processing at given cycles. First, the relationship between the load and efficiency will be described.

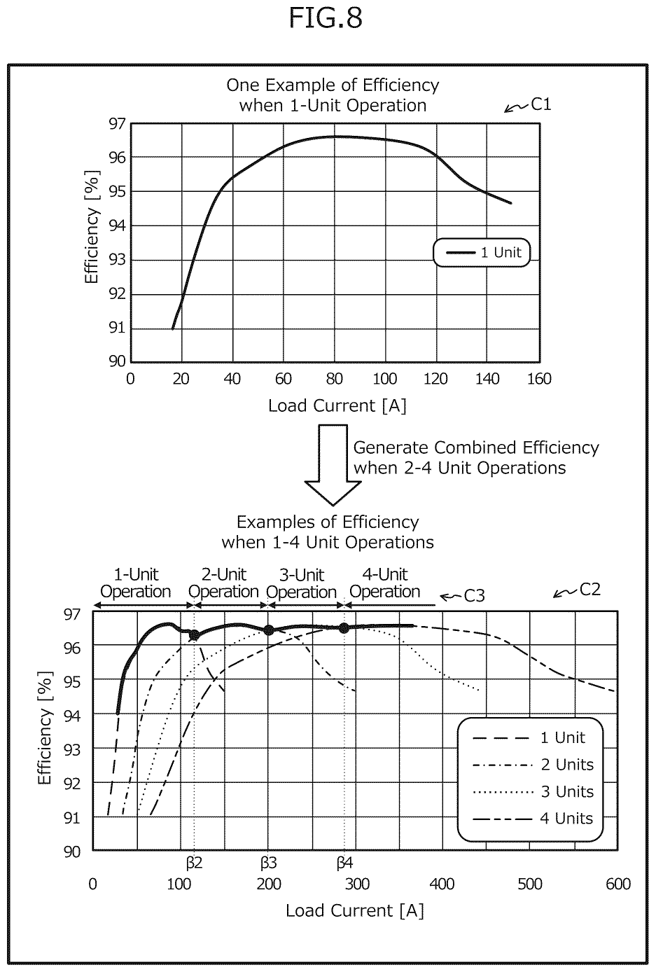

FIG. 8 is a graph illustrating examples of the relationship between the efficiency and the load current of the PSU 10. The reference symbol C1 indicates a graph in the case of a 1-unit operation (single-unit operation), and the reference symbol C2 indicates graphs in the cases of a 2-unit operation (dual-unit operation), 3-unit operation (triple-unit operation), and 4-unit operation (quadruple-unit operation). The load current is one example of the load. Examples of the efficiency include the power conversion efficiency (power efficiency) of the DC-DC converter 12 (or the AC-DC converter 11 and the DC-DC converter 12), for example.

As indicated by the reference symbol C1 in FIG. 8, the efficiency of the PSU 10 changes depending on the load current and has a peak at a certain load current. Hereinafter, a curve (graph) indicating such a relationship between the efficiency and the load current as illustrated in FIG. 8 may be referred to as an “efficiency curve.”

The reference symbol C2 indicates, with a bold solid line (bold ridge line), a combined efficiency curve generated by combining each efficiency curve in the cases of the 2-unit operation, 3-unit operation, and 4-unit operation in addition to the efficiency curve of the 1-unit operation. In the combined efficiency curve, the load current value at which the efficiency curve of the 1-unit operation and the efficiency curve of the 2-unit operation intersect is defined as 2.

Similarly, in the combined efficiency curve, the load current value at which the efficiency curve for the 2-unit operation and the efficiency curve for the 3-unit operation intersect is defined as 33, and the load current value at which the efficiency curve for the 3-unit operation and the efficiency curve for the 4-unit operation intersect is defined as B4. The current values at these intersection are change points at which the number N of operating PSUs that provides a higher efficiency changes in accordance with changes in the load current value, and are examples of one or more thresholds (switching points) for switching the number of PSUs 10 to be set to the operating state. As indicated by the reference symbol C2, as the number of PSUs 10 in operation increases, the load current range in which a higher efficiency is obtained shifts toward the higher load side.

The PSU determination unit 54 determines the number N of operating units in accordance with the load current (A) that is the sum of the output current Iout obtained from each PSU 10, for example, at given cycles, as described below (see the reference symbol C3):

$$1 - unit operation ( N = 1 ) : 0 \leq load current < β2$$

$$2 - unit operation ( N = 2 ) : β2 \leq load current < β3$$

$$3 - unit operation ( N = 3 ) : β3 \leq load current < β4$$

$$4 - unit operation ( N = 4 ) : β4 \leq load current$$

As indicated by the reference symbol C3, the efficiency can be improved (for example, optimized) when the load current is less than β4 by adaptively controlling the number N of operating units in accordance with the load current by the PSU determination unit 54.

The information for each point on the graph indicated by the reference symbol C1 or C2 in FIG. 8, in other words, the relationship among the efficiency, the load current, and the input voltage, may be measured and calculated in advance, and stored in the efficiency table 51b, for example. Furthermore, the PSU determination unit 54 may calculate the efficiency of each PSU 10 at timings such as given cycles or cycles longer than the given cycles, and may update the efficiency table 51b, for example. Note that the efficiency table 51b may be generated and updated for each PSU 10. For example, the efficiency table 51b may store the initial value of the efficiency value and the present value of the efficiency value for a load factor (current value).

Alternatively, the efficiency table 51b may store at least the relationship between the values of the load current corresponding to the timing for switching the number N of operating units, for example, the values of β2, β3, and β4, and the number N of operating units corresponding to each load current range (refer to the relationship described with reference to the reference symbol C3). Since the values of β (β2, β3, β4, . . . ) vary depending on the input voltage, the relationship with the input voltage may also be stored.

As one example, the efficiency table 51b may store the number N of operating units, the load current (or the output current Iout per PSU 10), the efficiency (initial value and current value), and the input voltage in association with each other. The efficiency may be calculated, for example, as (output power/input power x 100). In the case of direct current, the input power is calculated as input voltage X input current, and the output power is calculated as output voltage Vp×output current Tout. Note that the efficiency value at present may slightly decrease (for example, by a reduction amount of 0.1% or less relative to the initial value) depending on the degradation of components of the PSU 10.

The PSU determination unit 54 determines the PSUs 10 to be set to the operating state (and the PSUs 10 to be set to the standby state) such that the number of PSUs 10 in the operating state at present becomes equal to the determined number N of operating units. A method for determining the operating PSUs 10 will be described later.

The signal transmission unit 55 transmits the operation control signals S1a and S1b indicating the operating state to each of the determined PSUs 10. The signal transmission unit 55 also transmits the operation control signals S1a and S1b indicating the standby state to each of the PSUs 10 determined to be set to the standby state (i.e., determined not to be set to the operating state).

As described above, the control unit 5 controls the output state of each PSU 10 from the viewpoint of efficiency, based on the information obtained from the plurality of PSUs 10. Accordingly, one or more PSUs 10 can be operated in an optimal number along the region where a high efficiency can be achieved (see the bold solid line of the reference symbol C2 and the reference symbol C3 in FIG. 8), and the server 1 can be operated with a high efficiency.

Furthermore, since both the stabilization control and the efficiency control described above can be implemented using the configurations and functions provided in the server 1 (PSU 10, power supply controller 3, and processing device 4), it is possible to avoid the addition of special circuits or facilities and thereby reduce any increase in installation cost.

### (A-2-1) Example of Method for Determining Operating Units

Here, an example of a method for determining the operating PSUs 10 by the PSU determination unit 54 will be described.

Even when the PSUs 10 have identical performance and identical specifications, the efficiency of each PSU 10 tends to decrease (reduce) as its operating time increases. In other words, the shorter the operating time of a PSU 10, the higher its efficiency is. In addition, since each PSU 10 is composed of a plurality (for example, a large number) of components, even among a plurality of PSUs 10 manufactured with equivalent specifications, the efficiencies may differ from each other.

Therefore, the PSU determination unit 54 may, for example, select up to the number N of operating PSUs 10 from among the plurality of PSUs 10, in descending order of efficiency, for example. For example, the PSUs 10 may be assigned operating PSUs 10 in descending order of efficiency, as the first unit (see the reference symbol “1-Unit Operation” in C3 in FIG. 8), second unit (see “2-Unit Operation” in C3), third unit (see “3-Unit Operation” in C3), and fourth unit (see “4-Unit Operation” in C3). As a result, a PSU 10 with better efficiency than others can be preferentially selected as an operating PSU 10 and set to the operating state. By continuing such an assignment, the efficiencies of the plurality of PSUs 10 can be equalized.

Note that deterioration in the efficiency of a PSU 10 correlates with a decrease in the output voltage Vp due to degradation of components of the PSU 10. Accordingly, in the abnormality detection process, the abnormality determination unit 53 may perform an abnormality detection of the PSU 10 based on the efficiency table 51b in addition to the accumulated value table 51a. For example, the abnormality determination unit 53 may output, as abnormality information, the identification information of a PSU 10 of which efficiency is reduced to a given threshold or lower.

Moreover, swapping between operating PSUs 10 and standby PSUs 10 may be performed at a given timing. The given timing includes at least one timing selected from, for example, every given cycle, when it is determined to change the number N of operating units, and every cycle longer than the given cycle (e.g., every one day).

For example, the PSU determination unit 54 may swap the output states of one or more operating PSUs 10, with output states of the standby PSUs 10 in the same number as the number of the operating PSUs 10. As one example, when the number of PSUs 10 in the operating state is equal to or greater than the number of PSUs 10 in the standby state, the PSU determination unit 54 may switch all PSUs 10 in the standby state to the operating state and switch operating PSUs 10 in the same number as the number of PSUs 10 in the standby state, to the standby state. On the other hand, when the number of PSUs 10 in the operating state is less than the number of PSUs 10 in the standby state, the PSU determination unit 54 may switch standby PSUs 10 in the same number as the number of PSUs 10 in the operating state, to the operating state, and then switch operating PSUs 10 in the same number as the number of PSUs 10 in the standby state, to the standby state.

Since the operating time of each of the plurality of PSUs 10 can be equalized by performing such swapping of output states, the efficiencies of the PSUs 10 can also be equalized and the operational stability of the server 1 can be improved. In addition, since the failure rate of each of the plurality of PSUs 10 can also be reduced, the operational stability of the server 1 can be further improved also from the viewpoint of reducing the failure rate.

Note that the method for determining the operating PSUs 10 is not limited to the method described above. For example, the PSU determination unit 54 may change the output state only for units in the number corresponding to the difference between the number of operating PSUs 10 and the number of PSUs 10 currently in the operating state, while maintaining the output states at present for the other PSUs 10.

Furthermore, the PSU determination unit 54 may determine the operating PSUs 10 (and the standby PSUs 10) based on the accumulated value table 51a in place of or in addition to the determination method based on the efficiency table 51b. By determining the operating state and standby state of the PSUs 10 further based on the accumulated value table 51a, PSUs 10 having a lower likelihood of a failure may be selected as the operating PSUs 10, and PSUs 10 having a higher likelihood of a failure may be selected as the standby PSUs 10. Accordingly, the operational stability of the server 1 can be further improved.

### (A-2-2) Another Example of Method for Determining Number of Operating Units

There is a correlation between the value of the input voltage of the PSU 10 (DC-DC converter 12), or the internal temperature (component temperature) of the PSU 10 (DC-DC converter 12), and the efficiency curve. For example, as described above, the efficiency of the PSU 10 changes with the load current, but due to the influence of one or both of the input voltage and the internal temperature, the efficiency curve fluctuates, and the timing suitable for switching the number of operating units (switching points: 32, 33, 34) thus varies.

For example, the current value of the switching point when the input voltage value is relatively low may be smaller than the current value of the switching point when the input voltage value is relatively high. In contrast, for example, the current value of the switching point when the component temperature is relatively low may be smaller than the current value of the switching point when the component temperature is relatively high.

Therefore, for example, the relationship between the efficiency and the load current may be measured and calculated in advance for either or both of each segment of input voltage values and each segment of component temperatures, and stored in the efficiency table 51b. In this case, the PSU determination unit 54 may also update each efficiency table 51b based on the information obtained from each PSU 10 at timings such as every given cycle or every cycle longer than the given cycle. The efficiency table 51b may store, for example, at least the switching points of the number N of operating units and the relationship between the number N of operating units and the load current range corresponding to the load current ranges, for each segment of input voltage value, for each segment of component temperatures, or for each segment of input voltage values and each segment of component temperatures.

The PSU determination unit 54 may determine the number N of operating units by referring to the efficiency table 51b based on the load current, the input voltage, and the component temperature obtained by the information obtainment unit 52, for example. For example, the number N of operating units may be determined, among the entries that correspond to both the segment to which the input voltage belongs and the segment to which the component temperature belongs, based on the relationship between the load current and each switching point.

Alternatively, in the efficiency table 51b, the relationship between the efficiency and the load current corresponding to a reference value of the input voltage and a reference value of the component temperature may be set. In this case, the PSU determination unit 54 may modify (calculate) each switching point according to the amount of change or rate of change of the input voltage or the component temperature from the reference value.

In addition to each PSU 10, the information obtainment unit 52 may include one or both of segments of input voltage values and segments of component temperatures, as a unit for generating and updating the accumulated value table 51a, in the stabilization control. In this case, the abnormality determination unit 53 may perform the abnormality determination process for each PSU 10 in such a unit.

As described above, in the efficiency control, the power conversion efficiency can be further improved, by further taking into account one or both of the input voltage and the component temperature.

### (B) Example of Operation of Server According to One Embodiment

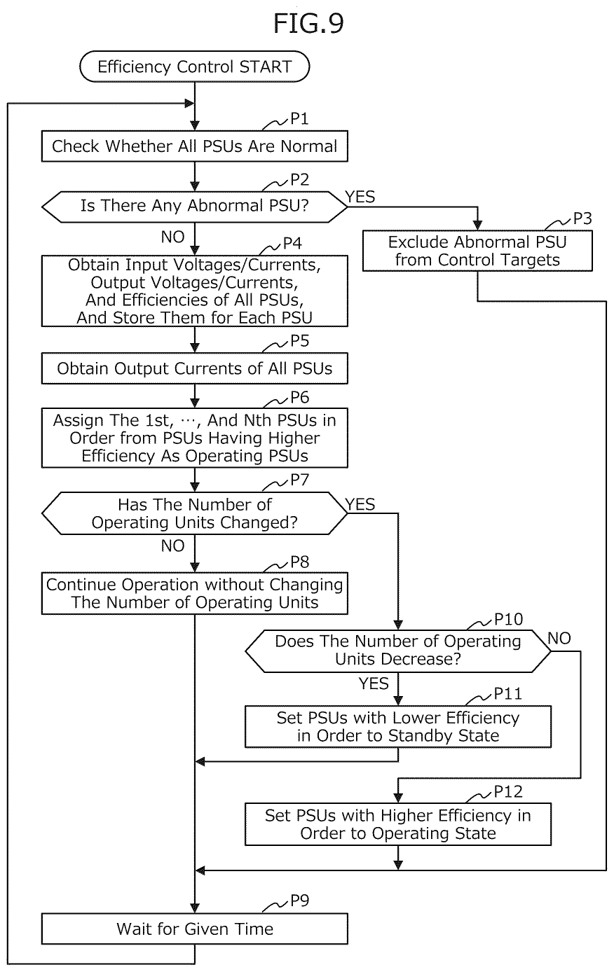

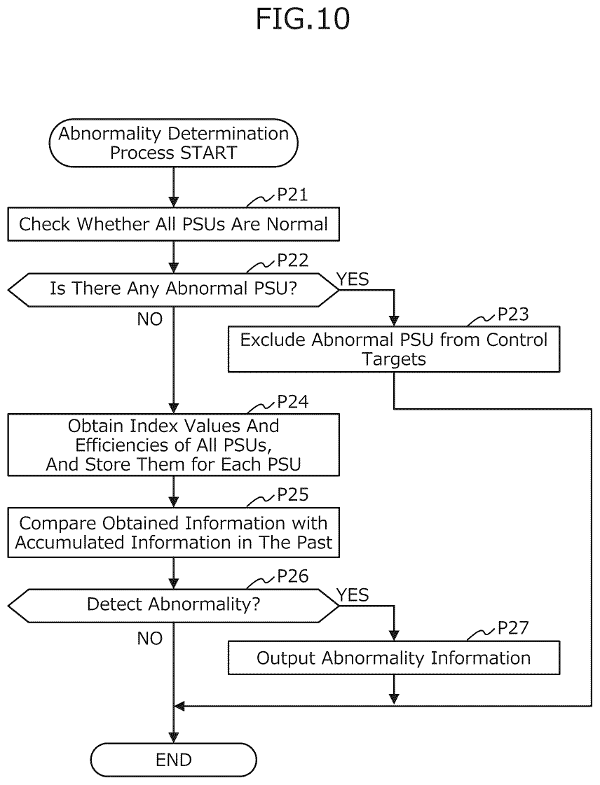

Next, an example of the operation of the server 1 according to one embodiment will be described. FIG. 9 and FIG. 10 are flowcharts for explaining an example of the operation of the server 1 according to one embodiment. In FIG. 9, for example, an example of the operation of the efficiency control performed by the control unit 5 and the plurality of PSUs 10 is described. In FIG. 10, for example, an example of the operation of the abnormality determination process in the stabilization control performed by the control unit 5 and the plurality of PSUs 10 is described.

In FIG. 9 and FIG. 10, for example, it is assumed that the efficiency control or abnormality determination process is started when an external power source has been connected to the PSUs 10 of the server 1, each PSU 10 has been turned on and supply of power has been started, the processing device 4 has started up, and the firmware of the control unit 5 has been started.

In the efficiency control, in Step P1 of FIG. 9, the control unit 5 checks whether or not all PSUs 10 to be controlled are normal. In Step P2, the control unit 5 determines whether or not there is any abnormal (for example, failed) PSU 10. If there is an abnormal PSU 10 (YES in Step P2), the process proceeds to Step P3. If there is no abnormal PSU 10 (NO in Step P2), the process proceeds to Step P4.

In Step P3, the control unit 5 excludes the abnormal PSU 10 from the control targets, and the process proceeds to Step P9. In this case, the control unit 5 may output information indicating that a failure of the PSU 10 has occurred.

In Step P4, the information obtainment unit 52 obtains the input voltages and the input currents, the output voltages Vp and the output currents Iout, and the efficiencies of all PSUs 10 to be controlled, and stores them for each PSU 10 (for example, updates the efficiency table 51b).

In Step P5, the information obtainment unit 52 obtains the values of the output currents Iout of all PSUs 10. Note that in Step P4 or P5, the information obtainment unit 52 may obtain the component temperature of the power conversion circuit 18 of all PSUs 10.

In Step P6, the PSU determination unit 54 determines the number N of operating units and assigns the PSUs 10 as the first, . . . , and Nth operating PSUs 10 in order from among from PSUs 10 having higher efficiency, based on the information obtained in Steps P4 and P5 and the efficiency table 51b.

In Step P7, the PSU determination unit 54 determines whether or not there is a change (difference) between the number N of operating units and the number of units currently operating. If there is no change (NO in Step P7), the process proceeds to Step P8. If there is a change (YES in Step P7), the process proceeds to Step P10.

In Step P8, the control unit 5 continues operation without changing the number of units currently operating. For example, the PSU determination unit 54 may transmit the operation control signals S1b to each PSU 10 from the signal transmission unit 55 in order to set the output states of the PSUs 10 to the operating state or the standby state assigned in Step P6. In Step P9, the control unit 5 waits for a given period, and the process proceeds to Step P1.

In Step P10, the control unit 5 determines whether the number of operating units will decrease (whether the number of units currently operating will be greater than the number N of operating units). If the number of operating units will decrease (YES in Step P10), the process proceeds to Step P11. If the number of operating units will not decrease (the number of units currently operating will be equal to or smaller than the number N of operating units) (NO in Step P10), the process proceeds to Step P12.

In Step P11, the control unit 5 sets the PSUs 10 with lower efficiency, in order from the PSUs 10 currently operating, to the standby state until the number of operating units becomes equal to N. Then, the process proceeds to Step P9.

In Step P12, the control unit 5 sets the PSUs 10 with higher efficiency, in order from among the current standby PSUs 10, to the operating state until the number of operating units becomes equal to N. Then, the process proceeds to Step P9.

In the stabilization control, each PSU 10 performs a feedback control of the switching time in order to maintain (raise) the output voltage Vp to the target output voltage Vt by the controller 17. The abnormality determination process may be performed, for example, at given intervals in the control unit 5, or once per day to once every several weeks.

In the abnormality determination process, in Step P21 of FIG. 10, the abnormality determination unit 53 checks whether or not all PSUs 10 to be controlled are normal. In Step P22, the abnormality determination unit 53 determines whether or not there is an abnormal (for example, failed) PSU 10. If there is an abnormal PSU 10 (YES in Step P22), the process proceeds to Step P23. If there is no abnormal PSU 10 (NO in Step P22), the process proceeds to Step P24.

In Step P23, the abnormality determination unit 53 excludes the abnormal PSU 10 from the control targets, and the process ends. Note that the abnormality determination unit 53 may output information indicating that a failure of the PSU 10 has occurred.

In Step P24, the information obtainment unit 52 obtains the index values and efficiencies of all PSUs 10 to be controlled for the given period, and stores them for each PSU 10 (for example, updates the accumulated value table 51a and the efficiency table 51b).

In Step P25, the abnormality determination unit 53 compares the obtained information with the accumulated information in the past (for example, the initial values in each of the accumulated value table 51a and the efficiency table 51b).

In Step P26, the abnormality determination unit 53 determines whether or not an abnormality has been detected. For example, the abnormality determination unit 53 determines one or both of whether or not the obtained index value is equal to or greater than the threshold, and whether or not the obtained efficiency is equal to or less than the threshold. If no abnormality has been detected (for example, there is no PSU 10 having an index value equal to or greater than the threshold, and there is no PSU 10 having an efficiency equal to or less than the threshold) (NO in Step P26), the process ends. If an abnormality has been detected (for example, there is a PSU 10 having an index value equal to or greater than the threshold, or there is a PSU 10 having an efficiency equal to or less than the threshold) (YES in Step P26), the process proceeds to Step P27.

In Step P27, the abnormality determination unit 53 outputs abnormality information including the identification information of the PSU 10 for which the abnormality is detected, and the process ends.

Note that the information obtained in Step P24 and the information compared in Step P25 may include only the index values out of the index value and the efficiency.

### (C) Others

The technique according to the above-described embodiment can be modified or varied as follows.

For example, the hardware configuration of the PSU 10 illustrated in FIG. 2 may be combined in any combination, or may be divided individually. In addition, the functional configurations of the control unit 5 illustrated in FIG. 6 may be combined in any combination, or may be divided individually.

Furthermore, the accumulated value table 51a and the efficiency table 51b stored in the control unit 5 may be stored in the controller 17 in at least one of the plurality of PSUs 10. In this case, instead of the control unit 5, one of the plurality of PSUs 10 may operate as a master, and the master controller 17 may embody the functions of the control unit 5 as one example of the control device. In order for the master controller 17 to control the plurality of PSUs 10, for example, each of the plurality of PSUs 10 may be connected via a dedicated control line, or the signal line L1 may be used.

Furthermore, although it has been assumed that the PSUs 10 other than the operating PSUs 10 are all in the standby state in one embodiment, at least one of them may be completely stopped. In the stabilization control, it is sufficient for one or more PSUs 10 to be set to the standby state, and the power loss is reduced when a PSU 10 is completely stopped than when it is in the standby state. Therefore, by controlling the plurality of PSUs 10 other than the operating PSUs 10 so that they are either in the standby state or in the completely stopped state, it is possible to respond to instantaneous load fluctuations while enhancing the loss reduction effect.

In addition, even in the standby state, a PSU 10 consumes power for operations of internal circuits and for cooling by a fan. Therefore, in the standby state, the controller 17 may reduce the oscillation frequency of the power conversion circuit 18. The oscillation frequency is one example of the operating frequency and may include, for example, the switching frequency of the FETs 18d and 18e described above. As a result, the higher the power consumption of a PSU 10 in the standby state, the greater the reduction in power consumption in the standby that can be achieved, thereby improving the overall efficiency of the server 1. Note that, for a PSU 10 of which power consumption in the standby state is sufficiently small, the reduction of the oscillation frequency of the power conversion circuit 18 may be omitted.

Furthermore, although the index value calculated by the controller 17 has been described as an accumulated value of the switching time, the increase amount Δt of the switching time, and the change amount Δv of the output voltage Vp, this is not limiting. For example, each of the switching time, the increase amount Δt of the switching time, and the change amount Δv of the output voltage Vp may be individually transmitted as individual index values from the controller 17 to the control unit 5. The information obtainment unit 52 may generate an individual accumulated value table 51a (index value table) based on these individual index values. In this case, in the abnormality determination process, the abnormality determination unit 53 may compare the threshold with respect to the initial value of each of the switching time, the increase amount Δt of the switching time, and the change amount Δv of the output voltage Vp, with each of these index value tables, and, when an abnormality is found in any of the index value tables, detect an abnormality of the corresponding PSU 10.

Furthermore, although the PSU 10 includes a signal indicating the internal temperature of the DC-DC converter 12 in the signals S1a and S1b, the PSU 10 may additionally or alternatively include a signal indicating the external temperature of the PSU 10 (for example, the housing temperature or ambient temperature of the DC-DC converter 12, or the housing temperature or ambient temperature of the PSU 10). In this case, the relationship between the efficiency and the load current may be measured and calculated in advance for each segment of the external temperature, and may be stored in the efficiency table 51b. Also, for example, in the efficiency table 51b, the PSU determination unit 54 may determine the number N of operating units based on the relationship between the load current and each switching point from among entries matching one or both of the segment to which the input voltage belongs, and the segment to which the component temperature or the segment to which the external temperature belongs. Alternatively, the efficiency table 51b may store the relationship between the efficiency and the load current corresponding to a reference value of the input voltage and a reference value of the component temperature or a reference value of the temperature. In this case, the PSU determination unit 54 may correct (calculate) each switching point according to the change amount or change ratio from the reference value of the input voltage, component temperature, or external temperature.

In one aspect, the present disclosure enables detection of an abnormality of a power supply unit, including a possibility of occurrence of a failure.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a power supply unit comprising a power conversion circuit comprising a switching element; and
a control device configured to control the power supply unit,
wherein the control device comprises a processor configured to perform a process comprising:
obtaining, from the power supply unit, an index value indicating a switching time of the switching element set in the power conversion circuit, and
detecting an abnormality of the power supply unit based on the obtained index value and an index value accumulated in the past.

2. The information processing apparatus according to claim 1,
wherein each of the index values is an index value that is related to a relationship between the switching time and an output voltage from the power supply unit in accordance with the switching time, and has a positive correlation with a degree of degradation of the power supply unit, and
the process comprises outputting information indicating the abnormality of the power supply unit when the obtained index value has increased by a given value or more from the index value accumulated in the past.

3. The information processing apparatus according to claim 1,
wherein each of the index values is related to an accumulated value of the switching time set in a following manner to obtain a target output voltage or an increase amount of the switching time, and a change amount of the output voltage from the power supply unit that changes in accordance with the switching time, during a given period.

4. The information processing apparatus according to claim 1,
wherein the process comprises:
obtaining information related to an efficiency from the power supply unit; and
detecting the abnormality of the power supply unit based on the index value obtained from the power supply unit and the information related to the efficiency.

5. The information processing apparatus according to claim 4,
wherein the information processing apparatus comprises a plurality of the power supply units, and
the processor is configured to perform the process comprising:
obtaining the index value from each of the plurality of power supply units;
obtaining the information related to the efficiency from each of the plurality of power supply units; and
determining, from the plurality of power supply units, a power supply unit that is to be set to a power supplying state for outputting power, and a power supply unit that is set to a stopped state for stopping the output of the power, based on at least one type of information of the index value and the information related to the efficiency obtained from each of the plurality of power supply units.

6. An abnormality detection method comprising: by a control device configured to control a power supply unit comprising a power conversion circuit comprising a switching element,
obtaining, from the power supply unit, an index value indicating a switching time of the switching element set in the power conversion circuit; and
detecting an abnormality of the power supply unit based on the obtained index value and an index value accumulated in the past.

7. The abnormality detection method according to claim 6,
wherein each of the index values is an index value that is related to a relationship between the switching time and an output voltage from the power supply unit in accordance with the switching time, and has a positive correlation with a degree of degradation of the power supply unit, and
the detecting comprises outputting information indicating the abnormality of the power supply unit when the obtained index value has increased by a given value or more from the index value accumulated in the past.

8. The abnormality detection method according to claim 6,
wherein each of the index values is related to an accumulated value of the switching time set in a following manner to obtain a target output voltage or an increase amount of the switching time, and a change amount of the output voltage from the power supply unit that changes in accordance with the switching time, during a given period.

9. The abnormality detection method according to claim 6, comprising
executing, by the control device, a process of obtaining information related to an efficiency from the power supply unit, and
wherein the detecting comprises detecting the abnormality of the power supply unit based on the index value obtained from the power supply unit and the information related to the efficiency.

10. The abnormality detection method according to claim 9, comprising,
by the control device,
controlling a plurality of the power supply units;
obtaining the index value from each of the plurality of power supply units;
obtaining the information related to the efficiency from each of the plurality of power supply units; and
determining, from the plurality of power supply units, a power supply unit that is to be set to a power supplying state for outputting power, and a power supply unit that is set to a stopped state for stopping the output of the power, based on at least one type of information of the index value and the information related to the efficiency obtained from each of the plurality of power supply units.
